(19) United States
(12) Patent Application Publication
(10) Pub. No.: US 2003/0199200 A1
(43) Pub. Date: Oct. 23, 2003

(54) Back-to-back modular plug coupler

(76) Inventor: Lawrence Chi-Yuen Chan, Richmond Hill (CA)

Correspondence Address: BLANK ROME LLP, 600 NEW HAMPSHIRE AVENUE, N.W., WASHINGTON, DC, 20037, US

(21) Appl. No.: 10/125,437

(22) Filed: Apr. 19, 2002

(51) Int. Cl. H01R 25/00

(52) U.S. Cl. 439/638

(57) ABSTRACT

The present invention is directed towards an in-line coupler for electrical and electronic components, having back-to-back jacks on opposite sides of a housing to electrically connect two separate electrical cables. The coupler includes a housing having two jacks on a front and rear side of the housing with a contact insert placed into the housing's center. The insert has a plurality of Z-shaped contacts secured to a base, with the contacts having contact ends extending in opposite directions to provide the contacts for the two jacks. The insert is introduced through an enlarged rear opening in the rear side of the housing, the base of the insert having a rear wall that closes a portion of the rear opening so that the front and rear jacks are similarly shaped.

### FIELD OF INVENTION

The present invention relates to an in-line coupler for various electrical and electronic components, having back-to-back jacks on opposite sides of a housing to electrically connect two separate electrical cables.

### BACKGROUND OF THE INVENTION

Multi-jack couplers are well known in the prior art and are used to perform a variety of functions, such as coupling two separate electrical lines together so that their length is increased, as shown in U.S. Pat. Nos. 4,806,117 to Johnston and 4,904,209 to Nelson, and splitting an output signal so that several electronic components can be connected to a single signal, as shown in U.S. Pat. No. 5,382,390 to Johnston et al.

However, the couplers in the prior art suffer from several disadvantages. First, many of the couplers are assembled from several pieces which increases their complexity and consequently, increases their manufacturing cost. Second, the metallic contacts in the couplers are bent into a variety of configurations to fit within the housing, increasing the overall length of the contacts, which increases their resistance and produces a lower quality signal.

### SUMMARY OF THE INVENTION

The present invention is directed to an in-line coupler for connecting two electrical lines or cables. The coupler includes a housing having a jack on a front and rear side of the housing with a contact insert placed into the housing's center. The insert has a plurality of Z-shaped contacts secured to a base, with the contacts having ends extending in opposite directions to form top and bottom mating sections for the two jacks. The insert is introduced through an enlarged opening in one side of the housing, with the base of the insert having a wall that seals a portion of the enlarged opening so that the front and rear jacks are similarly shaped when fully assembled.

### BRIEF DESCRIPTION OF THE DRAWINGS

FIG. 1 is a side sectional view of a back-to-back modular plug coupler of the present invention;

FIG. 2 is a perspective view of the coupler;

FIG. 3 is a front view of the contact insert;

FIG. 4 is a front view of the coupler;

FIG. 5 is a rear view of the coupler;

FIG. 6 is a side view of the coupler;

FIG. 7 is a side cut-away view along line 7-7 of FIG. 4; and

FIG. 8 is a side cut-away view along line 8-8 of FIG. 4.

### DETAILED DESCRIPTION OF DRAWINGS

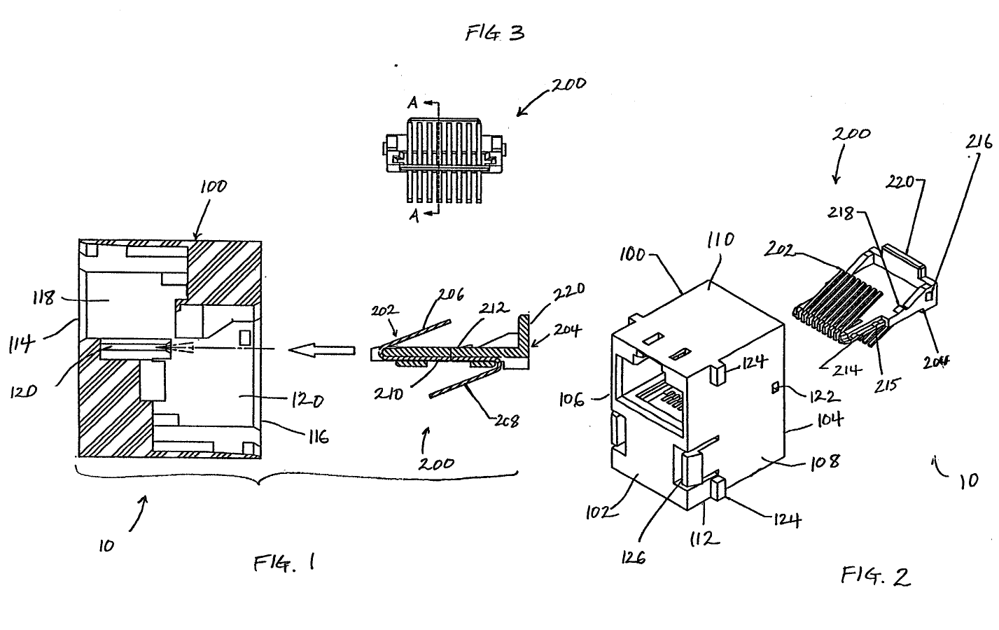

Referring now in detail to the drawings, FIGS. 1 and 2 show the back-to-back modular plug coupler 10 having a housing 100 and a contact insert 200. The housing 100 is a single plastic rectangular-shaped structure, having a front wall 102, a rear wall 104, two side walls 106 and 108, a top wall 110 and bottom wall 112. The use of the terms “top,” “bottom,” “front,” “rear” and “side” are intended to aid in the understanding of the figures of drawings, without limiting the invention. In use, the “front” wall may actually constitute the rear of the coupler and vice versa.

Front and rear openings 114, 116 are located in the front and rear walls 102, 104, respectively, to form the entrance of the front and rear jacks 118, 120 into which external electrical line plugs (not shown) are inserted into. The jacks 118, 120 are shaped to fit standard telephone or RJ plugs, but may be designed for other types of connectors. Additionally, the jacks 118 and 120 may be designed to accommodate electrical plugs of different shapes or types so that the coupler 10 functions as an adapter to join different types of electrical lines.

The insert 200, shown in FIGS. 1-3, has a plurality of Z-shaped electrical contacts 202 attached to a support platform 204. In the embodiment depicted in the figures, there are eight contacts 202 attached to the support platform 204. The insert 200 shown in FIG. 1 is a sectional view along line A-A in FIG. 3. The middle portion 210 of the electrical contacts 202 are attached to the base 212 of the support 204, so that the contact ends extend in opposite directions to form top mating contacts 206 and bottom mating contacts 208. The length of the top mating contacts 206, bottom mating contacts 208 and the middle portion may be modified to meet a variety of design criteria. However, as shown in FIG. 1, the preferred length of the top and bottom mating contacts 206, 208 extend past the midpoint of the middle portion 210 so that at least some portion of the top and bottom mating contacts 206, 208 overlap. The longer top and bottom mating contacts 206, 208 ensure a better connection with the contacts of an external plug, while the shortened overall length reduces the contact's 202 electrical resistance and produces a higher quality signal.

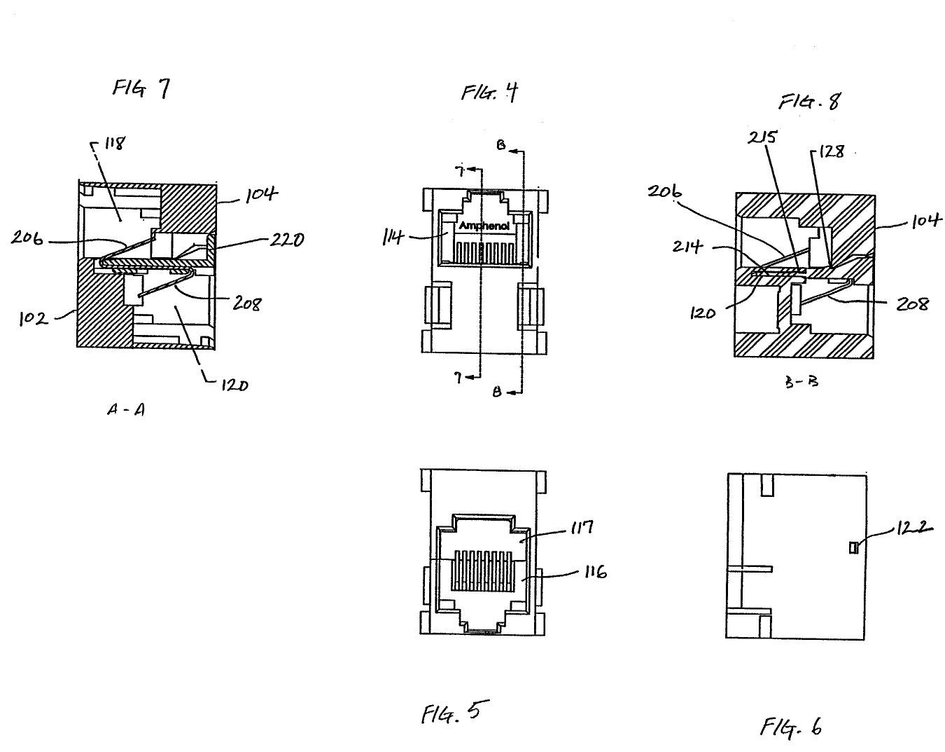

FIGS. 4 and 5 shows the front opening 114 in the top half of the housing 100 and a rear opening 116 in the bottom half of the housing 100, respectively, with the rear opening 116 being larger than the front opening 114. The rear opening 116 is enlarged to include a contact opening 117 to allow for the insertion of the top mating contacts 206 into the housing 100. When fully inserted, a wall 220 of the insert 200 covers the contact opening 117 and lies flush with the rear wall 104 of the housing. The front opening 114 and the rear opening 116 are then shaped and sized to accommodate the appropriate plugs.

To ensure proper alignment of the insert 200 within the housing, slides 214 are located on the sides of the insert 200. The slides 214 engages channels 120 in the housing 100 to align the insert 200 as it is introduced through the rear opening 116, shown in detail in FIG. 8.

To secure the insert 200 within the housing 100, the slides 214 have protrusions 215 along its surface that frictionally engage corresponding grooves in the channel 120, and side latches 216 that engage corresponding apertures 122 in the sides of the housing. Additionally, FIG. 8 shows interior corners 128 of the rear wall 104 engaging latches 218 on the top surface of the insert's base 212 to further secure the insert 200.

A comparison of FIGS. 7 and 8 show that the rear wall 104 extends into the rear opening 116 only along the sides, leaving the center portion open so that the top mating contacts 206 may pass through and into the interior of the housing 100. Once fully inserted, the top mating contacts 206 extend upward into the front jack 118 and the bottom mating contacts 208 extend downward into the rear jack 120.

The housing 100 may be used independently or may be placed into a separate structure, such as a wall. The housing 100 has alignment tabs 124 and resilient side latches 126 that allow the housing 100 to be quickly and easily aligned and locked to a wall or other structure.

Although preferred embodiments are specifically illustrated and described herein, it should be appreciated that many modifications and variations of the present invention are possible in light of the above teachings, without departing from the spirit or scope of the invention.

1. An in-line coupler for connecting electrical lines comprising:
a housing having a first side with a first opening defining a first jack and a second side with a second opening defining a second jack;
an insert comprising a plurality of Z-shaped electrical contacts secured to a base, the insert being introduced into the housing through the second opening.

2. The in-line coupler for connecting electrical lines of claim 1, wherein:
the first jack is located in a top half of the housing and the second jack is located in a bottom half of the housing; and
the electrical contacts includes top mating contacts and bottom mating contacts extending in opposite directions, the top mating contacts extending into the first jack and the bottom mating contacts extending into the second jack.

3. The in-line coupler for connecting electrical lines of claim 1, wherein:
the second opening is larger than the first opening to accommodate the insertion of the insert; and
the base of the insert has a wall that seals a portion of the second opening upon insertion into the housing so that the second opening is sized to receive a plug.

4. The in-line coupler for connecting electrical lines of claim 1, wherein:
the base of the insert includes at least one first latch that engages a portion of a second wall on the second side of the housing to secure the insert to the housing.

5. The in-line coupler for connecting electrical lines of claim 4, wherein:
the at least one first latch is located along the sides of the base and engage the second wall at an interior point in the housing.

6. The in-line coupler for connecting electrical lines of claim 1, wherein:
the sides of the base fit into corresponding channels in the housing to align the insert with the housing.

7. The in-line coupler for connecting electrical lines of claim 6, wherein:
the sides of the base include a ledge with at least one protrusion thereon, the ledge fitting within the channels and the at least one protrusion engaging grooves in the channels to frictionally secure the insert to the housing.

8. The in-line coupler for connecting electrical lines of claim 7, wherein:
the base includes at least one second latch that engages apertures in a sidewall of the housing.

9. The in-line coupler for connecting electrical lines of claim 1, wherein:
the housing is made of a single molded plastic component.

10. An in-line coupler for connecting electrical lines comprising:
a housing having a first side with a first opening defining a first jack and a second side with a second opening defining a second jack, the first jack is located in the top half of the housing and the second jack is located in the bottom half of the housing; and;
an insert having a plurality of electrical contacts secured to a base, the insert being introduced into the housing through the second opening.

11. The in-line coupler for connecting electrical lines of claim 10, wherein:
the second opening is larger than the first opening to accommodate the insertion of the insert, and the base of the insert has a wall that seals a portion of the second opening upon insertion into the housing so that the second opening is sized to receive a plug.

12. The in-line coupler for connecting electrical lines of claim 10, wherein:
the electrical contacts are Z-shaped.

13. The in-line coupler for connecting electrical lines of claim 10, wherein:
the base of the insert includes at least one first latch located along the sides of the base that engages a portion of a second wall on the second side of the housing at an interior point in the housing to secure the insert to the housing.

14. The in-line coupler for connecting electrical lines of claim 10, wherein:
the sides of the base fit into corresponding channels in the housing to align the insert within the housing.

15. A method for assembling an in-line coupler comprising the steps of:
providing a housing having a first side with a first opening defining a first jack and a second side with a second opening defining a second jack; and
inserting an insert comprising a plurality of Z-shaped electrical contacts secured to a base into the housing through the second opening.

16. The method for assembling an in-line coupler of claim 15, wherein:
the base includes at least one latch that engages a portion of a second wall on the second side of the housing to secure the insert to the housing; and
the sides of the base include a ledge with protrusion thereon, the ledge fitting within channels in the housing, and the protrusion engaging grooves in the channels to frictionally secure the insert to the housing.

17. The method for assembling an in-line coupler of claim 16, wherein:
the step of inserting the insert into the housing further comprises the step of aligning the ledge with the channels and pushing the insert into the housing so that the latch and the protrusions on the base engage the second wall and groove, respectively, to secure the insert to the housing.

18. The method for assembling an in-line coupler of claim 15, wherein:
the first jack is located in the top half of the housing and the second jack is located in the bottom half of the housing; and
the electrical contacts include top mating contacts and bottom mating contacts extending in opposite directions, the top mating contacts extending into the first jack and the bottom mating contacts extending into the second jack.
